(19) United States
(12) Patent Application Publication
(10) Pub. No.: US 2025/0004151 A1
(43) Pub. Date: Jan. 2, 2025

(54) QUICK LATCH SEISMIC DATA ACQUISITION OCEAN BOTTOM NODE AND METHOD

(71) Applicant: SERCEL, Carquefou (FR)

(72) Inventors: Dominique MAINETTI, Carquefou (FR); Abderrahim ABDELKRIM, Carquefou (FR); Jean-Jacques VIGNAUX, Villeneuve de Rivière (FR)

(21) Appl. No.: 18/343,079

(22) Filed: Jun. 28, 2023

(51) Int. Cl. G01V 1/16; G01V 1/38

(52) U.S. Cl. CPC G01V 1/162; G01V 1/3852

(57) ABSTRACT

An ocean bottom node for recording seismic waves includes a casing made of a battery housing and an electronics housing, both made of metal, electronics located inside the casing, a seismic sensor connected to the electronics and configured to detect the seismic waves, a battery located inside the casing and configured to supply power to the seismic sensor, and a latching mechanism configured to hold the battery housing in direct contact with the electronics housing, free of screws extending between the battery housing and the electronics housing.

### BACKGROUND

### Technical Field

Embodiments of the subject matter disclosed herein generally relate to methods and systems for seabed seismic data acquisition, and more particularly, to an ocean bottom node that uses a quick latch mechanism for attaching two metallic housings to each other for forming a closed casing for hosting electronics to be used for seismic data acquisition underwater.

### Discussion of the Background

Seismic data acquisition and processing may be used to generate a profile (image) of geophysical structures under the ground (subsurface). While this profile does not provide an accurate location for oil and gas reservoirs, it suggests, to those trained in the field, the presence or absence of such reservoirs. Thus, providing a high-resolution image of the subsurface is important, for example, to those who need to determine where the oil and gas reservoirs are located.

For marine acquisition, such a high-resolution image may be obtained with a seismic acquisition system as now discussed with regard to FIG. 1. The seismic acquisition system 100 includes plural ocean bottom nodes 102 distributed over the ocean bottom 101, by various means. Each ocean bottom node 102 includes, e.g., a hydrophone 104 for detecting a pressure wave, a processor 106 for processing the detected waves, a memory 108 for storing the seismic data, and a power source 110 for providing electrical power to these components. A vessel 120 tows one or more seismic sources 122 at a certain depth in the water, relative to the ocean surface 121. The seismic source 122 is configured to generate seismic waves 124. The seismic waves 124 propagate into the subsurface 126 and get reflected and/or refracted at various interfaces 128 in the subsurface. The reflected waves 130 are then detected by the hydrophone 104, and recorded in the memory 108 of the ocean bottom node 102.

The traditional ocean bottom nodes are designed based on the water depth at which they operate and the required autonomy. Generally speaking, a lower autonomy is required for shallow water depth. However, a long autonomy node is required for deep water applications where the nodes are generally deployed and positioned by ROV so they need more battery capacity. To address these two divergent requirements, most of the existing nodes have been designed to have two different configurations, one for shallow water and one for deep water, which involves different battery capacity, size and volume. For deep water seismic acquisition (from 100 meters to 3,000 meters), the casing for the node also needs to be pressure resistant and robust due to the exerted pressure and duration of the stay in place. Such OBN are generally made of titanium material to avoid corrosion and casing deformation due to the high hydrostatic pressure. The node design is also oversized by the use of reinforcement elements for resisting the high pressure. Thus, such nodes are very expensive.

For shallow water depth (less than 100 meters), the use of the titanium material and an oversized shape is not necessary. Thus, because an OBN for shallow water depth is deployed at a lower depth and for a shorter time operation, it is possible to use cheaper materials for the casing, for example, a polymeric material. Some deep water OBN could also benefit from this choice of material, if only moderate depth is foreseen, e.g., for a depth use up to 300 meters. However, it was observed that even for a deployment depth of less than 200 m, the polymeric casing deforms and water seeps inside the casing, compromising the hosted electronics. In addition, under some circumstances, the weight of the polymeric casing is too light, and the shallow OBN might not achieve a good contact with the seabed. Thus, a solution has been proposed in International Patent Application WO2021/224683, assigned to the assignee of this application, for using an outer metal housing in addition to the polymeric material housing (which is now used as an inner housing), to seal the two halves of the polymeric material housing together.

However, the inventors have observed that for intermediate depths, for example, between 300 and 700 m, the OBN with double housing (the polymer inner housing and metal outer housing) may still leak while the OBN with the titanium housing is too expensive. Thus, there is a need to design a different OBN for medium depth water operations (e.g., between 100 and 700 m) with a better compromise between the weight, cost, compacity, and reliability. While various ranges of depths were mentioned above, e.g., shallow water, medium depth, intermediate depths, etc., it is noted that the effective depths associated with these ranges are different from operator to operator and thus, the various embodiments discussed herein are not limited to the numbers provided herein. The operator of the seismic survey will decide, based on the conditions in which the seismic survey is operated, which depth range is suitable and which node is appropriate for the selected depth range. In other words, the nodes discussed later are not limited to the depth ranges defined herein, but may be used as seen fit by the operator of the seismic survey at any desired depth.

### BRIEF SUMMARY OF THE INVENTION

According to an embodiment, there is an ocean bottom node for recording seismic waves, and the ocean bottom node includes a casing made of a battery housing and an electronics housing, both made of metal, electronics located inside the casing, a seismic sensor connected to the electronics and configured to detect the seismic waves, a battery located inside the casing and configured to supply power to the seismic sensor, and a latching mechanism configured to hold the battery housing in direct contact with the electronics housing, free of screws extending between the battery housing and the electronics housing.

According to another embodiment, there is an ocean bottom node for recording seismic waves, and the ocean bottom node includes a casing made of a battery housing and an electronics housing, both made of metal, a seismic sensor connected to the electronics and configured to detect the seismic waves, a latching mechanism configured to hold the battery housing in direct contact with the electronics housing with no screw extending between the battery housing and the electronics housing.

According to yet another embodiment, there is a method for assembling an ocean bottom node, and the method includes placing a battery inside a battery housing of a casing, placing electronics inside the electronics housing of the casing, directly contacting the battery housing with the electronics housing to form a sealed inner chamber, attaching a latching mechanism to the battery and electronics housings, and securing the latching mechanism with corresponding screws to the battery and the electronics housings. Each of the battery housing and the electronics housing is made of metal.

### BRIEF DESCRIPTION OF THE DRAWINGS

For a more complete understanding of the present invention, reference

is now made to the following descriptions taken in conjunction with the accompanying drawings, in which:

FIG. 1 is a schematic diagram of a seismic data acquisition system that uses ocean bottom nodes;

FIG. 2 is an overview of an ocean bottom node having a casing made of aluminum and covered with a protection cover;

FIG. 3 illustrates the ocean bottom node of FIG. 2 with the protection cover removed;

FIGS. 4A and 4B illustrate a latching mechanism for attaching a battery housing to an electronics housing for the ocean bottom node of FIG. 2;

FIG. 5 illustrates, in cross-section, the latching mechanism being attached to the battery and electronics housings of the ocean bottom node;

FIG. 6 is an exploded view of the battery and electronics housings of the ocean bottom node showing the latching mechanism;

FIG. 7 is an exploded view of the battery and electronics housings of the ocean bottom node showing a connecting mechanism; and

FIG. 8 is a flowchart of a method for assembling the ocean bottom node with the latching mechanism.

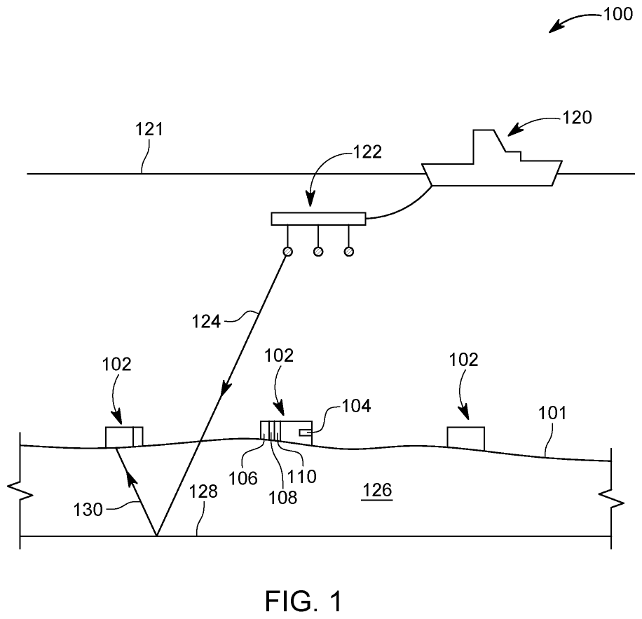

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a middle depth ocean bottom node that records seismic data. However, the embodiments to be discussed next are not limited to a middle depth ocean bottom node that records seismic data, but may be applied to other nodes that collect different data.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

It will be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

According to an embodiment, a novel, middle depth, ocean bottom node that is configured to record seismic data has most of its electronics housed in an aluminum casing. Other, preferably inexpensive, metals may be used for the casing. The aluminum casing is made from two or more parts and these parts are configured to fit together to form an inner chamber that is watertight. In this way, for the 100 to 700 m depth range, which is traditionally served by expensive titanium nodes, the present configuration achieves the desired structural integrity with no water leak at an affordable price. To ensure that the water tightness is maintained between the parts of the casing and also to ensure a quick and reliable connection between the parts of the casing, a quick latch mechanism is employed. The various parts are assembled together and maintained as a single unit with screws. If the casing is made of aluminum, the metal screws need only to keep the parts together, and do not need to have a high strength as the high sealing of the casing is achieved with the latching mechanism. This moreover also contributes to maintaining a lower cost of the product, since no re-design of the classical screws used for closing a casing (like in e.g., with a titanium case as disclosed in WO2020/208424) needs to be made for compatibility of the screws with the aluminum casing in marine environment.

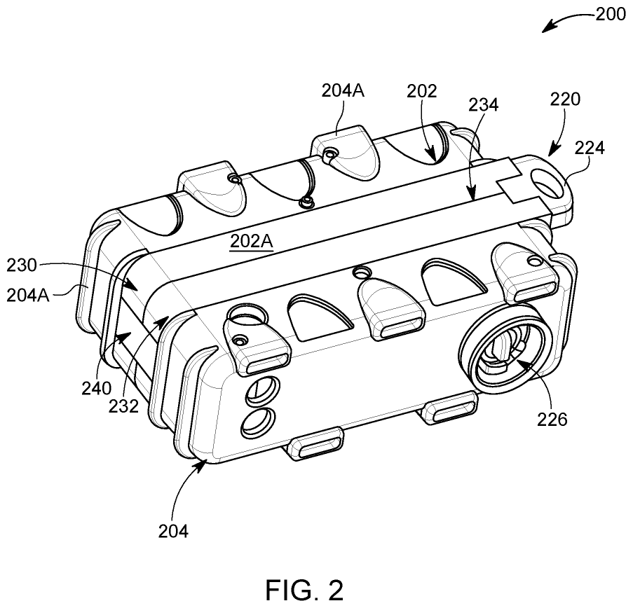

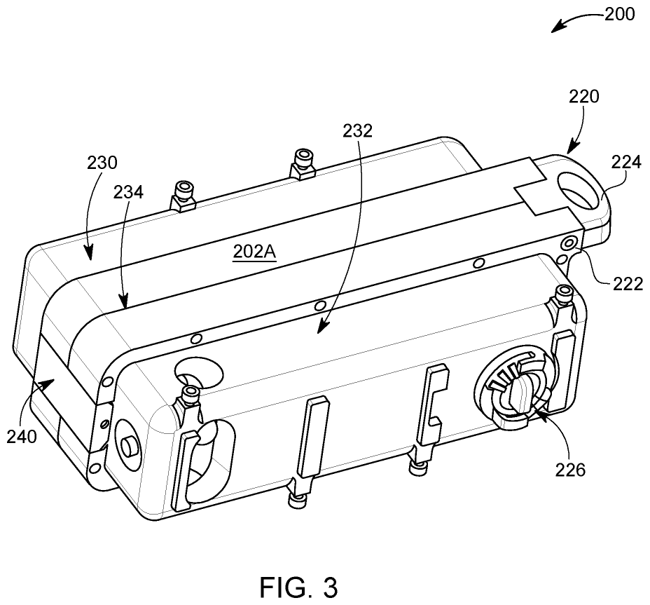

A middle depth OBN 200 is illustrated in FIG. 2, which shows a connecting mechanism 220 that is removably attached, for example, with a screw 222 (visible in FIG. 3), to the casing 202 of the OBN. While the connecting mechanism 220 is shown in the figure having an oval eye or loop 224, it may have a hook or other shaped element as necessary for the selected deploying method. In other words, depending on the selected method for deploying the OBNs, an appropriate connecting mechanism is selected by the operator and then attached to the casing 202 of the node 200.

FIG. 2 also shows a removable cap 226 that is configured to seal an electrical connection located inside the casing so that water cannot reach the electrical connection or the inside of the casing that stores the electronics. However, when the node is brought to the surface, the cap 226 can be removed (e.g., can be unscrewed from the casing) to expose the electrical connection, so that the electrical connection may be connected to electrical power from the vessel for recharging the battery and/or to a server for downloading the collected seismic data. Note that the electrical connection is electrically connected to the electronics inside the compounded housing and constitutes a gate to the memory and power supply of the node.

Regarding the casing 202 of the OBN 200, FIG. 2 shows that a soft protective cover 204 or jacket (made of deformable material like rubber) is placed over the casing 202 for protection from accidental bumping with the vessel, ROV, or stones on the ocean bottom. Note that protective cover 204 is omitted in FIG. 3 for fully showing the casing 202. However, protective cover 204 is designed in such a way that parts 202A of the bottom or top sides or both of the casing 202 are in direct contact with the water or the soil at the ocean bottom. Note that FIG. 2 shows only a top portion 202A of casing 202 being directly exposed to the ambient. However, there is a corresponding bottom portion (not shown in this figure) that is also not covered by the protective cover 204 so that the bottom portion is in direct contact with the ocean bottom. This direct coupling between casing 202 and the ocean bottom ensures that the small-frequencies movements of the particles of the ocean bottom are detected by a MEMS sensor located inside the node. The protective cover 204 may have plural bumps 204A for further protecting the node from shocks with the ocean bottom or the deploying vessel. Protective cover 204 may be made of a plastic or ceramic material, to protect the compounded casing 202. The bumps 204A are configured to engage with the ocean bottom material and stabilize the node relative to the ocean bottom. Casing 202 may be shaped as a flat pack or as a box, as shown in FIGS. 2 and 3, having the bottom base larger than the other sides so that a landing of the node on a side other than the base is unlikely. Casing 202 may be differently shaped if necessary.

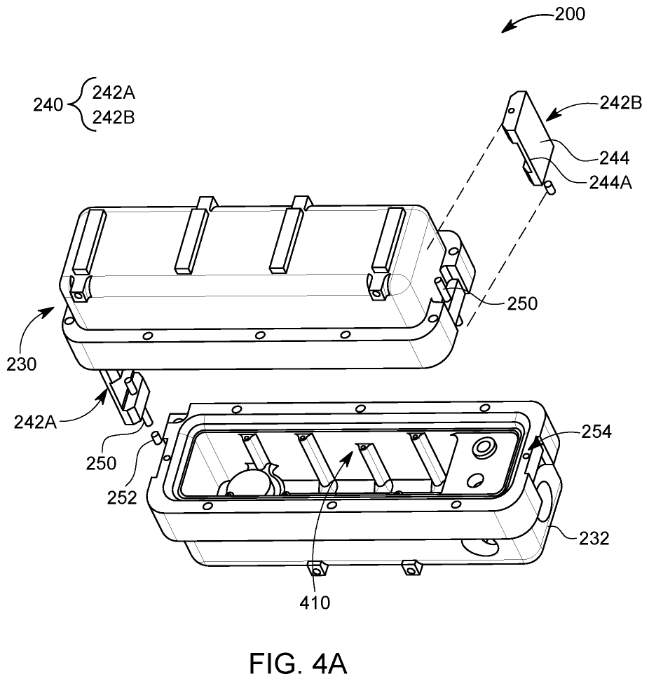

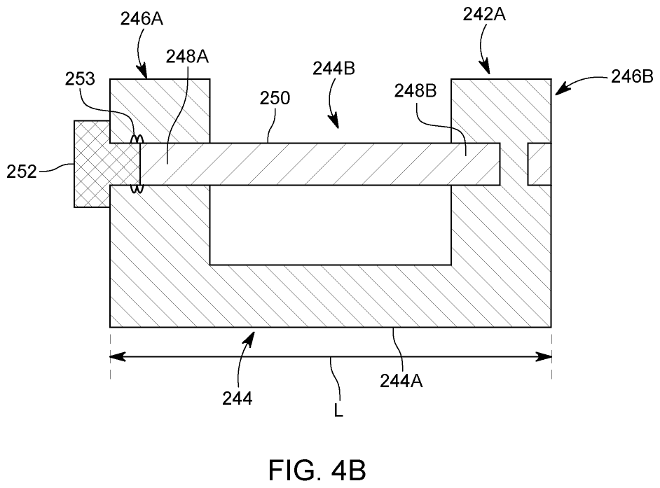

To withstand the ambient pressure between 100 and 700 m depth in the ocean, and also to prevent rust, casing 202 is entirely made in this embodiment of aluminum. As noted above, other inexpensive metals may be used for the casing. Note that as the node moves to depths higher than 100 m, up to 700 m, the ambient pressure is high enough to press the two halves 230 and 232 making up the casing 202, toward each other with enough force to achieve a tight water seal between them if the facing surfaces are machined enough. In other words, because of the pressure difference between the inner chamber 410 (see FIG. 4), which is defined by the two halves 230 and 232, and the exterior hydrostatic pressure, the two halves may be pressed toward each other with no additional seal in between so that no water passes the interface 234 between the two halves. Note that in one embodiment, there is an additional seal (for example, a gasket) between the two halves 230 and 232 for sealing the potential irregularities between the facing surfaces of the two halves.

Moreover, preferably, a kind of vacuum is established within the housing, so that the ambient pressure also achieves the tight water seal for the casing when the node 200 is on board of the vessel. In one embodiment, the pressure in the casing is around 0.5 bar. This also avoids condensation inside the housing and allows protection against corroding the electronic components.

The two halves 230 and 232 are configured to be secured to each other by a latching mechanism 240, as shown in FIGS. 2 and 3, for preventing the two halves to slide relative to each other or to even uncouple from each other. The latching mechanism 240 is shown in more detail in FIGS. 4A and 4B and includes at least two latches 242A and 242B, which are located on the sides of casing 202. In this embodiment, each latch is placed on the smallest side of casing 202. However, one skilled in the art would understand that the latches may be placed at different locations or more than two latches may be used.

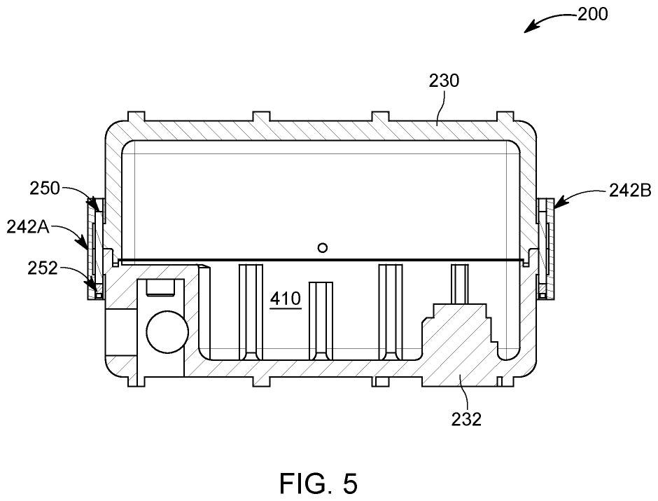

Each latch is made of a solid body 244 made of aluminum, or another material, which is compatible with housing 202 of the node. The solid body 244 has a flat side 244A, as shown in FIG. 4B, and an opposite irregular side 244B. Two shoulders 246A and 246B are formed/attached on the irregular face 244B, and each shoulder has a corresponding hole 248A and 248B, respectively. The two holes 248A and 248B are sized to receive a pin 250. The pin fully extends through the first hole 248A and only partially through the second hole 248B as the second hole has one of its external end blocked. Pin 250 has a length smaller than an external length L of the body 244 so that both ends of the pin 250 are fully situated inside the corresponding shoulders 246A and 246B, as shown in FIG. 4B. The pin may have a simple shape, for example, a straight cylinder. To prevent the pin 250 from detaching from the body 244 when in use, a screw 252 is added at one of the shoulders (246A in FIG. 4B) to block one end of the pin while the other end of the pin 250 is prevented from exiting the second shoulder 246B due to the hole 248B being closed. Because the screw 252 does not have the same function as the attaching screws, and does not have to be as strong as the attaching screws, it may be made of plastic, or “standard” aluminum as no strength function is necessary for this case. In this way, after the bodies 244 of the latches 242A and 242B are attached to the two halves 230 and 232, a corresponding pin 250 is provided through the shoulders of the bodies and through corresponding holes 254 of the halves 230 and 232, and then each pin 250 is secured with a corresponding screw 252, as illustrated in FIG. 5. For being able to screw the screw 252 in the shoulder 246A, matching threads 253 are formed both in the screw 252 and in the bore of the hole 248A, as schematically illustrated in FIG. 4B. Note that pin 250 has no threads.

Casing 202 is shown in FIGS. 2 to 5 to be made of two halves 230 and 232. One skilled in the art would understand that more parts may be used to form the casing 202. However, in the embodiment shown in FIGS. 2 to 5 only two parts are used to make the entire casing 202. The first half 230 is configured to host a battery pack 610. The battery pack 610 is configured to supply all the necessary power for the node 200. For this reason, the first half 230 is also called the battery housing. Note that the term “half” is not used herein to mean a ½ fraction of the casing 202, only to mean one of two parts that form the casing. In other words, the size or volume of the two halves 230 and 232 do not have to be the same. Even their shapes may be different.

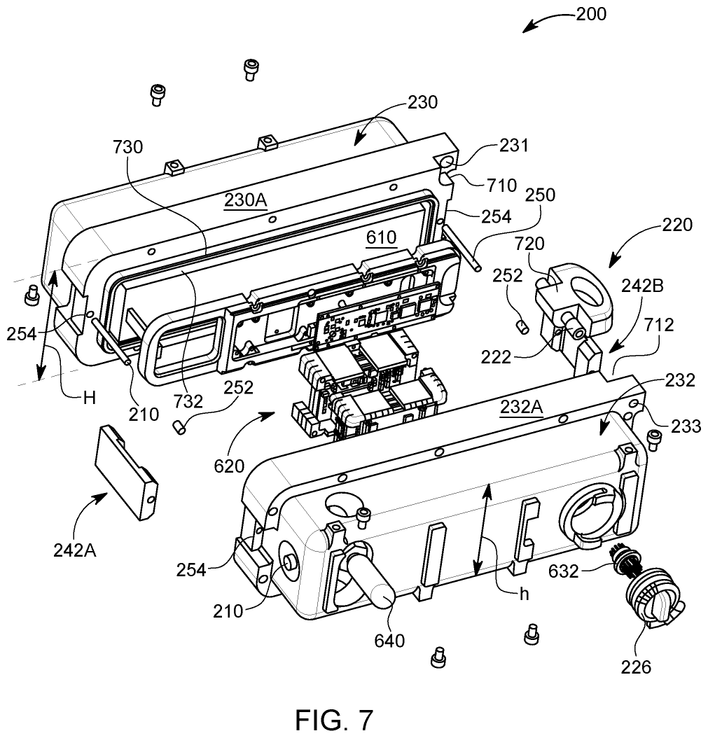

The other half 232 is configured to hold the electronics of the node, and for this reason it is also called the electronics housing 232. While previous implementations of an OBN used to have a strength plate between the various parts forming the casing of the node, in this embodiment, there is no strength plate located between the battery housing 230 and the electronics housing 232. The electronics housing 232 might be configured to hold a pinger 210, as shown in FIG. 7, which would be directly exposed to the ambient water. Note that the embodiments shown in FIGS. 2-6 do not require a pinger. However, if desired, a pinger may be attached to, or housed in, those nodes.

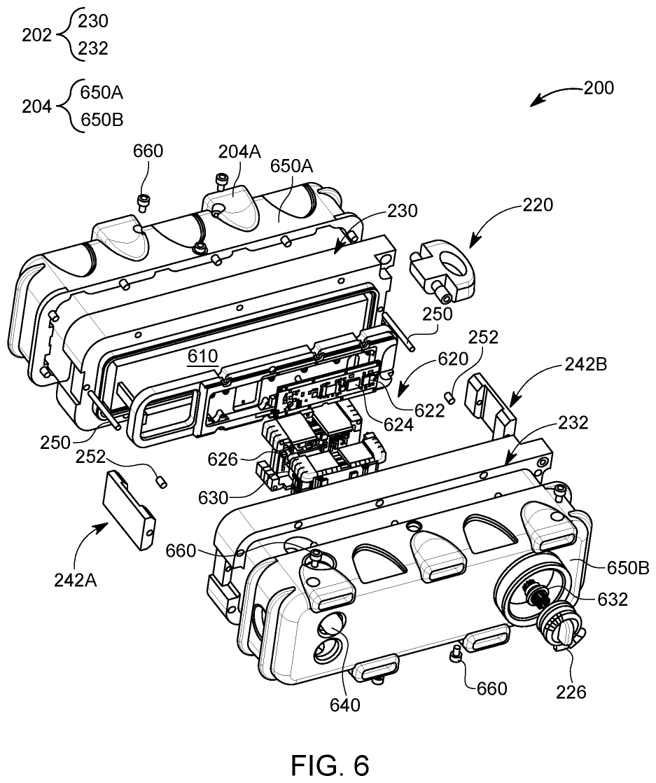

Chamber 410 is configured to house the electronics 620, as illustrated in FIG. 6. The electronics 620 may include a processor 622, memory 624, and a seismic sensor 626, for example, a particle motion sensor like a MEMS sensor or a geophone. Further electronic components may be placed inside the chamber 410. For example, as illustrated in FIG. 6, a power and data retrieval card (management) 630 may also be placed inside the chamber 410, for managing the power from the battery 610 and also the data exchange with a base, when the OBN is on shore and is being prepared for deployment. In this regard, the card 630 is configured to communicate through a port 632 with a power source (not shown) and/or a data server (not shown) on shore and the port 632 is covered with the cap 226, previously discussed, to prevent the ambient water to contact the electrical contacts of the port. The power source is used to recharge the battery 610 and the data server is used to receive all the recorded seismic data from the node 200.

FIG. 6 shows a hydrophone 640 that is attached to the electronics housing 232, to electrically communicate with the electronics 620. Note that the hydrophone 640 directly interacts with the ambient water for accurately measuring the water pressure changes. However, a base (not shown) of the hydrophone 640, which is in electrical communication with the electronics 620, seals the chamber 410 so that water does enter the chamber.

The protective cover 204 may have a first half bumper 650A that is configured to conform over the first half 230 and also a second half bumper 650B, which is configured to conform over the second half 232. The protective cover 204 may be made of an elastic material, for example, thermo-polyurethane (TPU) material. The reason for having this elastic material over the housing is, as noted above, to protect the MEMS sensor 626 from unwanted shocks. Also, the clock of the electronics 620 is very sensitive and needs protection from shock. A shock can happen when the node is deployed in the water, as the node falls freely to the ocean bottom. The elastic material is configured to absorb part of the shock. Note that in one embodiment, the node 200 has no protective cover. This might happen if no MEMS sensors are used, or if the MEMS sensor and the clock are designed to not be affected by the impact with the ocean bottom. If protective cover 204 is present, then it may be attached with screws 660 to the corresponding halves 230 and 232, as illustrated in FIG. 6.

FIG. 7 shows the node 200 open, so that electronics 620 is visible, and no protective cover. The hydrophone 640 and the port 632 are also shown removed from the electronics housing 232. The latches 242A and 242B and their components are also shown removed from casing 202 for a better understanding of their positioning and how they connect together the two halves 230 and 232. FIG. 7 further shows the connecting mechanism 220 and corresponding screw 222. Note that each of the halves 230 and 232 has corresponding holes 231 and 233, formed to accommodate the screw 222. The holes 231 and 233 are formed in corresponding lips 230A and 232A of the halves 230 and 232. The two lips 230A and 232A are configured to mate with each other and form the seal interface 234 shown in FIGS. 2 and 3. A foot print of the lips 230A and 232A is larger than a foot print of the halves 230 and 232, as illustrated in FIG. 7, for the purpose of having increased strength. In essence, the mating of the two lips 230A and 232A when the casing is fully assembled produces enough strength to replace the strength plate that is typically used in the traditional nodes. In other words, a height H of the lips is larger than a height h of the body of the halves 230 and 232. The lips 230A and 232A extend around a perimeter of the halves 230 and 232 and each lip has at least two holes 254 for accommodating the pins 250. The width of the lips at the location of the holes 254 is calculated to be exactly half of the distance between the two shoulders 246A and 246B of each body 244 of the latches 242A and 242B so that each latch snugly fits around the lips of the two halves 230 and 232.

The lips 230A and 232A, when placed together, form a partial recess 710, 712 for receiving a neck 720 of the connecting mechanism 220, as also shown in FIG. 7. Thus, when the two halves 230 and 232 are assembled, the neck 720 of the connecting mechanism 220 is placed into the recess 710, 712, and the screw 222 is placed through the holes 231 and 233 of the lips 230A and 232A and through a corresponding hole in the neck 720 so that the connecting mechanism 220 is fixedly attached to the casing 202, as shown in FIG. 2. In one application, to further enhance the seal between the two lips 230A and 232A, one or more o-rings 730 may be placed around an internal shoulder 732 of one or both halves 230 and 232.

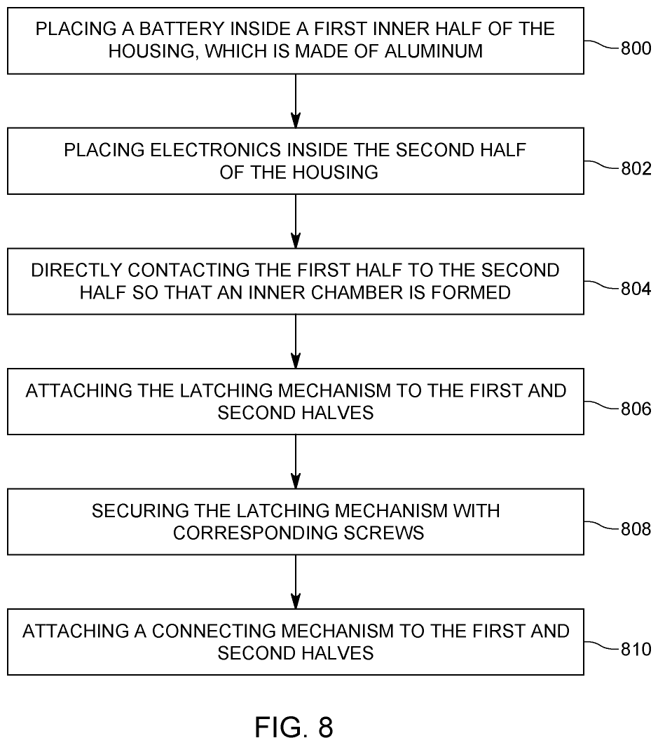

A method for assembling the ocean bottom node 200 in anticipation of acquiring seismic data is now discussed with regard to FIG. 8. The method includes a step 800 of placing the battery 610 inside the first half 230 of the casing 202, which is made of aluminum, a step 802 of placing electronics 620 inside the second half 232 of the casing 202, a step 804 of directly contacting the first half 230 to the second half 232 so that the inner chamber 410 is formed, a step 806 of attaching the latching mechanism 240 to the first and second halves, a step 808 of securing the latching mechanism 240 with corresponding screws, and a step 810 of attaching the connecting mechanism 220 to the first and second halves 230 and 232. A step for under-pressurizing the housing is performed either after step 808 or step 810.

The disclosed embodiments provide an aluminum housing ocean bottom node that is configured to collect seismic data when deployed in a middle depth zone, i.e., a zone where the depth of the ocean bottom is between 100 and 700 m. A quick latching mechanism is used to connect the halves of the housing to each other. No screw is extending from one half to the other half for holding together the two halves. This configuration is preferred in view of the low cost of aluminum, but the housing can be made of any other suitable metal, with corresponding choices for the quick latching mechanism.

Although the term “ocean” is used in this application, one skilled in the art would understand that the OBN can be deployed in a lake, pond, brackish water, river, etc., i.e., any body of water. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. An ocean bottom node for recording seismic waves, the ocean bottom node comprising:
a casing made of a battery housing and an electronics housing, both made of metal;
electronics located inside the casing;
a seismic sensor connected to the electronics and configured to detect the seismic waves;
a battery located inside the casing and configured to supply power to the seismic sensor; and
a latching mechanism configured to hold the battery housing in direct contact with the electronics housing, free of screws extending between the battery housing and the electronics housing.

2. The node of claim 1, wherein the latching mechanism includes first and second latches, each latch being configured to attach to corresponding lips of the battery and electronics housings.

3. The node of claim 2, wherein each latch includes a pin and a screw.

4. The node of claim 3, wherein the lips of the battery and the electronics housings have corresponding holes for receiving the pin.

5. The node of claim 4, wherein each latch has first and second shoulders, and each shoulder has a corresponding hole for receiving the pin.

6. The node of claim 5, wherein the first shoulder has treads for receiving the screw and the second shoulder has one end of the corresponding hole closed.

7. The node of claim 6, further comprising:
the screw, which is configured to be attached to the first shoulder, after the pin was inserted into the first and second shoulders, to secure the pin in place.

8. The node of claim 1, wherein both the battery housing and the electronics housing are made of aluminum.

9. The node of claim 1, wherein lips of the battery and electronics housings include holes with no threads for accommodating pins of the latching mechanism.

10. The node of claim 1, further comprising:
a connecting mechanism attached to each of the battery and electronics housings and configured to have a loop.

11. An ocean bottom node for recording seismic waves, the ocean bottom node comprising:
a casing made of a battery housing and an electronics housing, both made of metal;
a seismic sensor connected to the electronics and configured to detect the seismic waves; and
a latching mechanism configured to hold the battery housing in direct contact with the electronics housing with no screw extending between the battery housing and the electronics housing.

12. The node of claim 11, further comprising:
electronics located inside the casing;
a battery located inside the casing and configured to supply power to the seismic sensor; and
a hydrophone attached to the electronics housing and partially in direct contact with the ambient of the casing.

13. The node of claim 11, wherein the latching mechanism includes first and second latches, each latch being configured to attach to corresponding lips of the battery and the electronics housings.

14. The node of claim 13, wherein each latch includes a pin and a screw.

15. The node of claim 14, wherein the lips of the battery and the electronics housings have corresponding holes for receiving the pin.

16. The node of claim 15, wherein each latch has first and second shoulders, and each shoulder has a corresponding hole for receiving the pin.

17. The node of claim 16, wherein the first shoulder has treads for receiving the screw and the second shoulder has one end of the corresponding hole closed.

18. The node of claim 17, further comprising:
the screw, which is configured to be attached to the first shoulder, after the pin was inserted into the first and second shoulders to secure the pin in place.

19. The node of claim 12, wherein both the battery housing and the electronics housing are made of aluminum.

20. A method for assembling an ocean bottom node, the method comprising:
placing a battery inside a battery housing of a casing;
placing electronics inside the electronics housing of the casing;
directly contacting the battery housing with the electronics housing to form a sealed inner chamber;
attaching a latching mechanism to the battery and electronics housings; and
securing the latching mechanism with corresponding screws to the battery and the electronics housings,
wherein each of the battery housing and the electronics housing is made of metal.
